(19) United States
(12) Patent Application Publication
(10) Pub. No.: US 2022/0253233 A1
(43) Pub. Date: Aug. 11, 2022

(54) MEMORY CONTROL DEVICE AND METHOD

(71) Applicant: TOSHIBA TEC KABUSHIKI KAISHA, Tokyo (JP)

(72) Inventor: Mitsuhiro Kataoka, Singapore Singapore (SG)

(21) Appl. No.: 17/525,998

(22) Filed: Nov. 15, 2021

(30) Foreign Application Priority Data
Feb. 5, 2021 (JP) 2021-017500

(51) Int. Cl. G06F 3/06

(52) U.S. Cl. CPC G06F 3/0655; G06F 3/0604; G06F 3/0652; G06F 3/0679

(57) ABSTRACT

According to one embodiment, provided area memory control device and a program capable of preventing deterioration of a flash memory used for storing data that is repeatedly rewritten and used, and extending an operating life of the flash memory. The memory control device performs writing and erasing on a flash memory, and the memory control device includes: a write processing unit, when there is a blank region in which data is not written in a predetermined storage region included in the flash memory, and a capacity of the blank region is sufficient for a capacity of data to be written, configured to write the data to be written in the blank region; and an erase processing unit, when there is no blank region, or the capacity of the blank region is insufficient for the capacity of the data to be written, configured to erase the entire storage region.

### CROSS-REFERENCE TO RELATED APPLICATION

This application is based upon and claims the benefit of priority from Japanese Patent Application No. 2021-017500, filed on Feb. 5, 2021, the entire contents of which are incorporated herein by reference.

### FIELD

Embodiments described herein relate generally to a memory control device, a method, and a Point-of-Sale terminal.

### BACKGROUND

In related art, for example, a sales data processing apparatus such as a POS terminal prints and outputs (dispenses) a receipt or the like by a printer provided in the sales data processing apparatus. Some printers that dispense such receipts or the like store various settings set by a user of the POS terminal, and refer to the settings when dispensing the receipts . In such a printer, the setting is rewritten every time the user changes the setting.

A flash memory is often used for storing the above settings since the flash memory is optimized in consideration of cost effectiveness and the like. In the flash memory, as is well known, a guarantee value of the number of times of rewriting is determined, and when the number of times of rewriting exceeds the guarantee value, it is considered that deterioration of the flash memory progresses to some extent, and thus it can be said there is a high possibility that the flash memory fails .

Various proposals for preventing the deterioration of the flash memory as described above and extending an operating life of the flash memory is proposed, for example, as in a related art. However, it is difficult to say that these proposals are easily applicable and effective proposals which are required in an apparatus such as the printer provided in the POS terminal, for example, that is expected to have a certain degree of usage.

### DESCRIPTION OF THE DRAWINGS

FIG. 1 is a perspective view illustrating an external appearance of a POS terminal and a printer according to an embodiment;

FIG. 2 is a block diagram illustrating a configuration of the printer;

FIG. 3 is a block diagram illustrating a functional configuration of the printer;

FIG. 4 is a diagram illustrating capacity division of a setting storage unit;

FIG. 5 is a diagram schematically illustrating a method of using the setting storage unit;

FIG. 6 is a diagram illustrating an example of management information in a region to which various setting values are to be written in a table format;

FIG. 7 is a flowchart schematically illustrating a flow of a process performed by a control unit as a write processing unit and an erase processing unit; and

FIG. 8 is a diagram illustrating transition of a storage state of the setting storage unit.

### DETAILED DESCRIPTION

In general, according to one embodiment, there are provided a memory control device and a method capable of preventing deterioration of a flash memory used for storing data that is repeatedly rewritten and used, and extending an operating life of the flash memory.

A memory control device according to an embodiment performs writing and erasing on a flash memory, and the memory control device includes: a write processing unit, when there is a blank region in which data is not written in a predetermined storage region included in the flash memory, and a capacity of the blank region is sufficient for a capacity of data to be written, configured to write the data to be written in the blank region; and an erase processing unit, when there is no blank region, or the capacity of the blank region is insufficient for the capacity of the data to be written, configured to erase the entire storage region. According to another embodiment, method executed by a computer included in a memory control device that performs writing and erasing on a flash memory involves when a blank region in which data is not written in a predetermined storage region included in the flash memory exists, and a capacity of the blank region is sufficient to accommodate data to be written, writing the data to be written in the blank region; and when there is no blank region, or the capacity of the blank region is insufficient to accommodate the data to be written, erasing the entire storage region.

### First Embodiment

An embodiment will be described with reference to the drawings. In the present embodiment, an example in which the present disclosure is applied to a printer that is used by being connected to a Point Of Sales (POS) terminal used in a store to dispense a receipt or the like is described, but the application is not limited thereto.

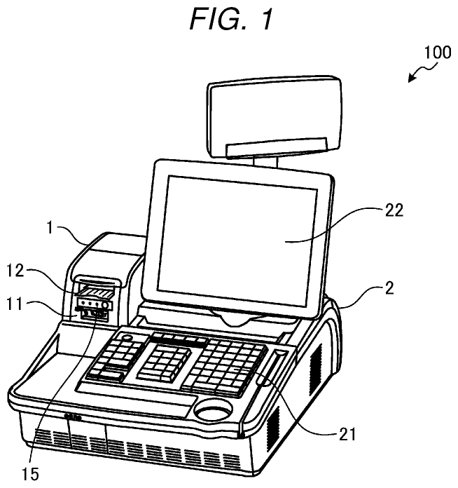

FIG. 1 is a perspective view illustrating an external appearance of a POS terminal 2 and a printer 1 according to the embodiment. A POS system 100 includes the POS terminal 2 and the printer 1 connected to the POS terminal 2.

The POS terminal 2 includes a keyboard 21 and a display unit 22. The POS terminal 2 receives an instruction to close a payment of one transaction and dispense a receipt via the keyboard 21. The POS terminal 2 receives various operations via the keyboard 21, and receives settings related to the dispensing (printing and cutting) of the receipt performed by the printer 1.

Examples of the setting related to the dispensing of the receipt performed by the printer 1 include a size of roll-shaped paper used as receipt paper, and a type of a cutting method after printing (full cutting for completely cutting the paper after printing, or partial cutting for maintaining a part of the paper such as a center or an end of the paper without cutting) .

The printer 1 prints printing data received from the POS terminal 2, which is a host device, on the paper contained in a housing 11, and dispenses the printed paper as a receipt from a receipt dispensing port 12. The printer 1 switches between full cutting and partial cutting in response to a command received from the POS terminal 2, and cuts the paper.

An accommodation unit that accommodates roll-shaped paper (receipt paper) is provided in the housing 11 of the printer 1. The housing 11 is divided into a lower housing and a cover serving as a lid for the lower housing. The accommodation unit can be opened and closed by the cover.

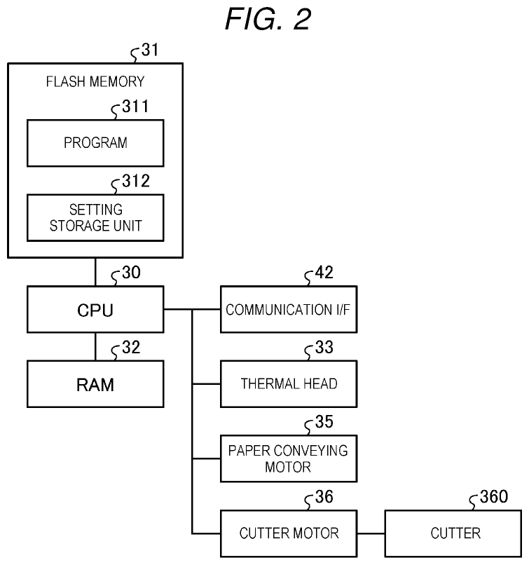

The receipt dispensing port 12 is provided on a front surface of the printer 1. The receipt paper subjected to a printing process by a thermal head 33 (see FIG. 2) is discharged from the receipt dispensing port 12, and is subjected to the full cutting or the partial cutting by a cutter 360 (see FIG. 2) provided on a back side of the receipt dispensing port 12 to be dispensed as the receipt.

An operation display unit 15 is provided below the receipt dispensing port 12 on a front surface of the lower housing of the printer 1. The operation display unit 15 includes a plurality of LEDs for making a notification of operation states of the printer 1, such as out of paper or paper jam, and various operation buttons.

FIG. 2 is a block diagram illustrating a configuration of the printer 1. The printer 1 includes a central processing unit (CPU) 30 that executes various calculations and controls each unit. A flash memory 31, which is a non-volatile memory, and a random access memory (RAM) 32, which is a volatile memory, are connected to the CPU 30 via a bus.

The flash memory 31 stores a program 311 and a setting storage unit 312. The setting storage unit 312 stores various settings. The various settings include, for example, the size of the roll-shaped paper and the cutting method at the time of cutting the receipt paper . The settings stored in the setting storage unit 312 are not limited to the example. It is assumed that the setting stored in the setting storage unit 312 is expected to be repeatedly rewritten to some extent in use of the printer 1 that refers to the setting when a receipt is dispensed, and a data capacity required for storing the settings is determined in advance.

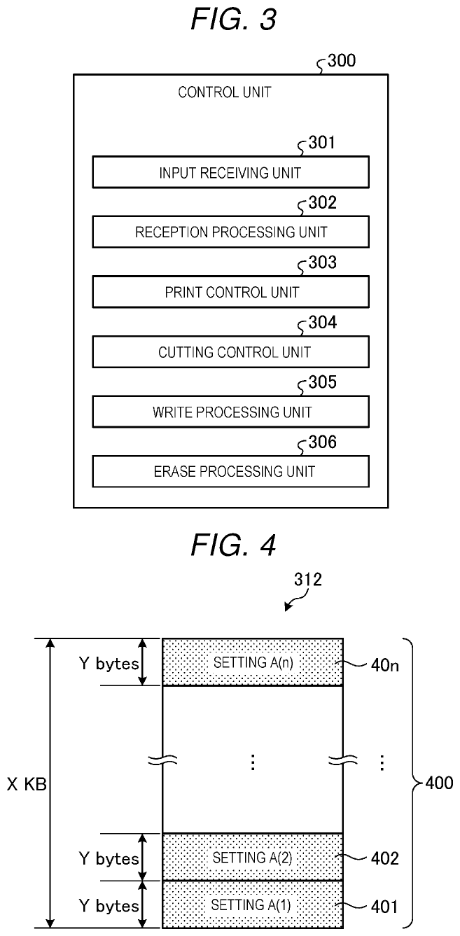

The program 311 has a module configuration including various functional units (an input receiving unit 301, a reception processing unit 302, a print control unit 303, a cutting control unit 304, a write processing unit 305, and an erase processing unit 306) illustrated in FIG. 3, which will be described later. The CPU 30 (processor) reads the program 311 from the flash memory 31, and loads and deploys the above-described units the program 311 in a main storage device. As a result, the input receiving unit 301, the reception processing unit 302, the print control unit 303, the cutting control unit 304, the write processing unit 305, and the erase processing unit 306 are generated in the main storage device.

A communication interface (I/F) 42, the thermal head 33, a paper conveying motor 35, a cutter motor 36, and the like are connected to the CPU 30 via a bus.

The communication I/F 42 is an interface such as a universal serial bus (USB), and the CPU 30 is connected to a CPU of the POS terminal 2 via the communication I/F 42. The thermal head 33 includes a plurality of heating elements arranged in a straight line, and thermally transfers the printing data received from the POS terminal 2 onto thermal paper (paper).

The paper conveying motor 35 functions as a power source for rotating a platen roller facing the thermal head 33 to convey the paper. The cutter motor 36 controls an operation of the cutter 360 provided in the vicinity of the receipt dispensing port 12, so that the paper is cut by the full cutting or the partial cutting.

Next, a functional configuration of the program 311 will be described. FIG. 3 is a block diagram illustrating a functional configuration of the printer 1. The CPU 30 implements the control unit 300 by loading the program 311 in the RAM 32 and executing the program 311. The control unit 300 includes the various functional units (the input receiving unit 301, the reception processing unit 302, the print control unit 303, the cutting control unit 304, the write processing unit 305, and the erase processing unit 306) illustrated in FIG. 3.

The input receiving unit 301 receives operation inputs from the various operation buttons of the operation display unit 15. The input receiving unit 301 further receives inputs of detection signals from various sensors included in the printer 1.

For example, the input receiving unit 301 receives a cover open signal indicating that the cover is opened with respect to the lower housing from a sensor that detects opening and closing of the cover. The input receiving unit 301 further receives, from the same sensor, a cover close signal indicating that the cover is closed with respect to the lower housing of the printer 1.

The reception processing unit 302 receives, from the POS terminal 2 via the communication I/F 42, the printing data and the command indicating the cutting method of the paper. That is, the reception processing unit 302 receives, from the POS terminal 2, the printing data and any one of a full cutting command, a partial cutting command, and a mixed-cutting command.

The full cutting command is an instruction to cut the paper by the full cutting in which the paper is cut in a width direction. The partial cutting command is an instruction to cut the paper by the partial cutting in which a part of the paper is not cut in the width direction. The mixed-cutting command is an instruction to cut a plurality of pieces of paper by mixing both the full cutting and the partial cutting when the plurality of pieces of paper are continuously printed and the plurality of pieces of paper are dispensed in one set.

The mixed-cutting command may be a command simply indicating mixed cutting. That is, for example, in the mixed cutting, a front end of a first piece of paper and a rear end of a last piece of paper may be fully cut, and the pieces of paper maybe partially cut, and a combination of the full cutting and the partial cutting may be uniformly fixed and operated. In such an operation, the mixed-cutting command may simply indicate the mixed cutting.

Alternatively, in the mixed-cutting command, the full cutting and the partial cutting may be indicated for each piece of paper. In this case, the POS terminal 2 may be set to distribute the cutting method in accordance with the printing data.

When the reception processing unit 302 receives the printing data, the print control unit 303 drives the paper conveying motor 35 to convey the paper toward a print position of the thermal head 33. The print control unit 303 outputs the printing data received by the reception processing unit 302 to the thermal head 33 to cause the thermal head 33 to thermally transfer the printing data to the paper, thereby controlling a printing operation.

The cutting control unit 304 controls the operation of the cutter 360 to cut the paper by the cutting method corresponding to the command received from the POS terminal 2. When the paper is cut without the command from the POS terminal 2, the cutting control unit 304 cuts the paper by the cutting method stored in the setting storage unit 312.

The write processing unit 305 records, for example, the command instructing the cutting method received from the POS terminal 2 in the setting storage unit 312 as information indicating the cutting method. Details of a data write process performed by the write processing unit 305 will be described later.

The erase processing unit 306 erases a predetermined range of the setting storage unit 312 of the flash memory 31 at a predetermined timing. The erasing is performed by data erasing for each block, that is, so-called block erasing. As long as there is no blank region in a storage region to be written by the write processing unit 305, or a capacity of a blank region is insufficient for a capacity of data to be written, the erase processing unit 306 erases the entire storage region. Prior to a next writing which is performed after the write processing unit 305 finishes using all the small regions obtained by dividing the block by an integer, the erase processing unit 306 erases data stored in the block.

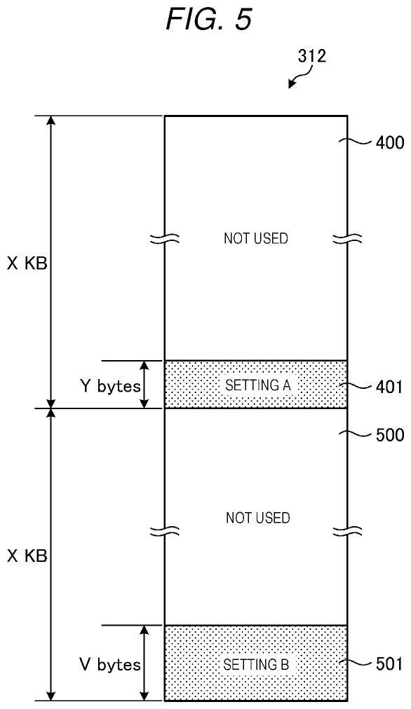

Here, the printer 1 according to the present embodiment is an example of a memory control device that performs writing and erasing on the flash memory 31 . A write process performed by the write processing unit 305 and an erase process performed by the erase processing unit 306 will be described in more detail . FIG. 4 is a diagram illustrating capacity division of the setting storage unit 312. FIG. 5 is a diagram schematically illustrating a method of using the setting storage unit 312.

In the present embodiment, as shown in FIG. 4, at the time of writing a predetermined setting A, a capacity (X kilobytes) of a predetermined storage region 400 to which the setting A is to be written is made to correspond to a capacity of a block which is a unit subjected to the erase process in the flash memory 31. In addition, a capacity (Y bytes) of small regions 401, 402, . . . , and 40n associated with one-time writing of the setting A is set to be a capacity obtained by the capacity of the storage region 400 being divided by an integer (n). Here, Y bytes are equal to or larger than a data capacity of the setting A.

In a case where a specific numerical value is illustrated, when a unit capacity of the block erasing performed by the erase processing unit 306 is 64 kilobytes, the capacity (X kilobytes) of the storage region 400 for the setting A is set to 64 kilobytes. In addition, when a capacity required for recording of the setting A is 500 bytes or less at the maximum, since 64 kilobytes (=65536 bytes) divided by 128 (n) equals 512 bytes, the capacity (Y bytes) of the small regions 401, 402, . . . , and 40n is set to 512 bytes. This numerical value example is shown for easy understanding, and should be changed according to the unit capacity of the block erasing and a data capacity of a setting.

Next, as shown in FIG. 5, the storage region 400 to be erased at one time by the block erasing is all provided for recording of the setting A, and a region that is other than the storage region 400 for the setting A and is not erased by the block erasing is allocated as a storage region 500 for recording the other setting B. In addition, a capacity (Vbytes) of a small region 501 associated with one-time writing of the setting B is also set to be a capacity obtained by the unit capacity (X kilobytes) of the block erasing being divided by an integer (m). This integer m and the integer n described above do not have to coincide with each other.

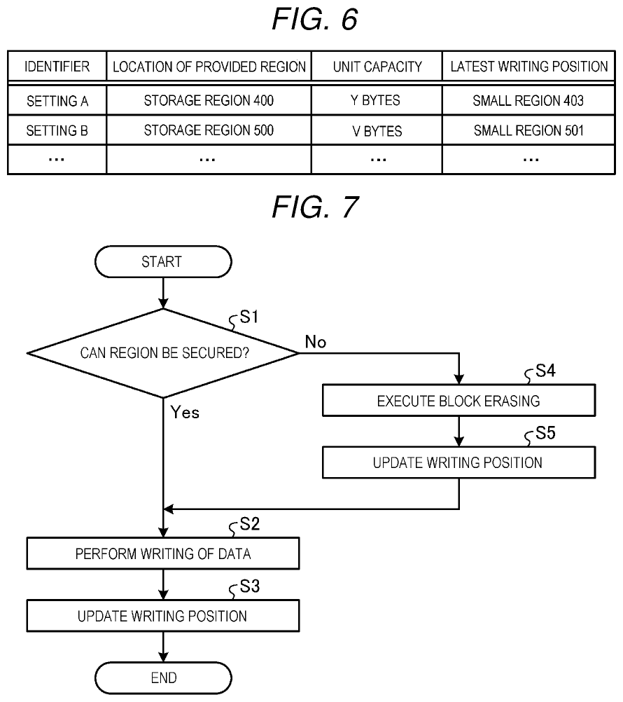

When writing the setting A in the storage region 400, the write processing unit 305 sequentially moves the small regions 401, 402, . . . , and 40n in accordance with an update of the setting A and uses the small regions 401, 402, . . . , and 40n. FIG. 6 is a diagram illustrating an example of management information on the storage regions 400, 500, and the like to which the various settings A, B, and the like are to be written in a table format . The flash memory 31 also stores the management information.

The management information stores an identifier (name or the like) of the setting A, a location of a region provided for the writing of the setting A, a capacity (unit capacity) required for the one-time writing of the setting A, and a latest writing position in association with each other. According to the illustrated example, the identifier “setting A”, the “storage region 400”, the “Y bytes”, and the “small region 403” are stored in association with each other.

By referring to the management information, the write processing unit 305 determines that a value currently valid as the setting A is recorded in the small region 403. The write processing unit 305 further determines that the past setting A, which is currently invalid, is recorded in the small regions 401 and 402 of the storage region 400. The write processing unit 305 further determines that remaining small regions 404 to 40n in the storage region 400 are blank regions.

Next, an example of a process executed by the printer 1 will be described. FIG. 7 is a flowchart schematically illustrating a flow of a process performed by the control unit 300 as the write processing unit 305 and the erase processing unit 306.

When there is an instruction to rewrite a setting, the control unit 300 serves as the write processing unit 305 to determine whether a region can be secured (Act 1) . That is, the write processing unit 305 determines whether there is a blank region sufficient for the capacity (Y bytes) of the data to be written (setting A) in the predetermined storage region 400 included in the flash memory 31.

In Act 1, when there is a blank region in the predetermined storage region 400 included in the flash memory 31 sufficient for the capacity of the data to be written (Yes in Act 1) , the write processing unit 305 writes the data to be written in a small region 40x which is a part (or all) of the blank region (Act 2). Here, the small region 40x is any one of the small regions 401, 402, . . . , and 40n, and is a small region next to a small region 40x-1 in which the writing is performed. When no writing is performed in the storage region 400, the write processing unit 305 writes the data in the first small region 401.

Next, the write processing unit 305 updates the latest writing position of the management information (FIG. 6) (Act 3), and ends this process.

On the other hand, in Act 1, when a blank region in the predetermined storage region 400 included in the flash memory 31 is not sufficient for the capacity of the data to be written (No in Act 1), the control unit 300 serves as the erase processing unit 306 to execute the block erasing (Act 4). That is, the erase processing unit 306 erases the entire storage region 400. Thereafter, the control unit 300 updates the latest writing position of the management information (FIG. 6) (Act 5), and the process proceeds to Act 2. In Act 5, the latest writing position becomes the blank region. As a result, the write processing unit 305 referring to the management information determines that all the small regions 401 to 40n of the storage region 400 are blank.

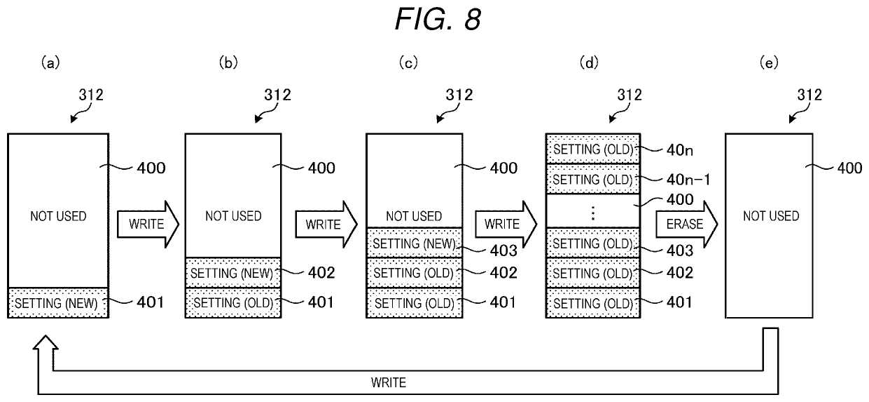

FIG. 8 is a diagram illustrating transition of a storage state of the setting storage unit 312. By performing the process described in the flowchart, for example, as illustrated in FIG. 8(a), when a latest setting is written in the small region 401 of the storage region 400, at the time of writing a next setting, a latest setting is written in the next small region 402, and the setting of the small region 402 becomes valid.

Further, in the next setting writing, the latest setting is written in the small region 402 of the storage region 400 as shown in FIG. 8(b), and in a further next setting writing, a latest setting is written in the small region 403 as shown in FIG. 8(c) . The setting stored in the region before the region in which the latest setting is written is invalid.

Then, as shown in FIG. 8(d), when all the small regions 401 to 40n of the storage region 400 are written and there is no blank in the storage region 400, the storage region 400 is subjected to the block erasing before a next writing (FIG. 8(e)) . Thereafter, a latest setting is written in the first small region 401.

As described above, in the example described in the present embodiment, according to the related art, the storage region 400 is subjected to the erase process each time the setting A is rewritten, and deterioration of a region to be rewritten each time for the setting A progresses, whereas according to the present embodiment, since the erase process is performed once for the setting A instead of 128 times of rewriting for the setting A, it is theoretically possible to suppress the deterioration to one 128-th of that in the related art.

Therefore, according to the printer 1 of the present embodiment, it is possible to prevent deterioration of the flash memory 31 used for storing data that is repeatedly rewritten and used, and to extend an operating life of the flash memory 31.

The program executed by the memory control device according to the present embodiment is provided by being incorporated in a ROM or the like in advance.

The program executed by the memory control device according to the present embodiment may be provided by being recorded in a computer-readable recording medium such as a CD-ROM, a flexible disk (FD), a CD-R, or a digital versatile disk (DVD) as a file of an installable format or an executable format.

The program executed by the memory control device according to the present embodiment may be stored on a computer connected to a network such as the Internet and provided by being downloaded through the network. The program executed by the memory control device according to the present embodiment may be provided or distributed through the network such as the Internet.

The embodiments have been described, but this embodiment is presented only as an example, and is not intended to limit the scope of the disclosure. Indeed, the novel embodiment described herein may be embodied in a variety of other forms; furthermore, various omissions, substitutions and changes in the form of the embodiment described herein may be made without departing from the spirit of the disclosure. The embodiment and a modification thereof are included in the scope and the spirit of the disclosure and are also included in the invention described in the scope of claims and an equivalent scope thereof.

What is claimed is:

1. A memory control device that performs writing and erasing on a flash memory, comprising:
a write processing component, when a blank region in which data is not written in a predetermined storage region included in the flash memory exists, and a capacity of the blank region is sufficient to accommodate data to be written, configured to write the data to be written in the blank region; and
an erase processing component, when there is no blank region, or the capacity of the blank region is insufficient to accommodate the data to be written, configured to erase the entire storage region.

2. The memory control device according to claim 1, wherein
at the time of writing a predetermined setting, the write processing component cause a capacity of the predetermined storage region to which the setting is to be written to correspond to a capacity of a block which is a unit subjected to an erase process in the flash memory,
a capacity of a region associated with one-time writing of the setting is set to be a capacity obtained by the capacity of the predetermined storage region being divided by an integer, and
each region obtained by dividing the block by the integer is sequentially used in accordance with an update of the setting.

3. The memory control device according to claim 2, wherein
prior to a next writing which is performed after the write processing component finishes using all regions obtained by dividing the block by the integer, the erase processing component erases data stored in the block.

4. The memory control device according to claim 1, wherein
the write processing component updates the latest writing position of the management information.

5. The memory control device according to claim 1, wherein
when the erase processing component erases the entire storage region, a control component updates a latest writing position of management information, and the write processing component, referring to the management information, determines that all small regions of the storage region are blank.

6. A method executed by a computer included in a memory control device that performs writing and erasing on a flash memory, comprising:
when a blank region in which data is not written in a predetermined storage region included in the flash memory exists, and a capacity of the blank region is sufficient to accommodate data to be written, writing the data to be written in the blank region; and
when there is no blank region, or the capacity of the blank region is insufficient to accommodate the data to be written, erasing the entire storage region.

7. The method according to claim 6, further comprising:
at the time of writing a predetermined setting, causing a capacity of the predetermined storage region to which the setting is to be written to correspond to a capacity of a block which is a unit subjected to an erase process in the flash memory;
setting a capacity of a region associated with one-time writing of the setting to be a capacity obtained by the capacity of the predetermined storage region being divided by an integer; and
obtaining each region by dividing the block by the integer sequentially used in accordance with an update of the setting.

8. The method according to claim 7, further comprising:
prior to a next writing which is performed after the write processing component finishes using all regions obtained by dividing the block by the integer, erasing data stored in the block.

9. The method according to claim 6, further comprising:
updating the latest writing position of management information.

10. The method according to claim 6, further comprising:
when erasing the entire storage region, updating a latest writing position of management information, and referring to the management information, determining that all small regions of the storage region are blank.

11. A Point-of-Sale terminal, comprising:
a receipt printer; and
a memory control device that performs writing and erasing on a flash memory, comprising:
a write processing component, when a blank region in which data is not written in a predetermined storage region included in the flash memory exists, and a capacity of the blank region is sufficient to accommodate data to be written, configured to write the data to be written in the blank region; and
an erase processing component, when there is no blank region, or the capacity of the blank region is insufficient to accommodate the data to be written, configured to erase the entire storage region.

12. The Point-of-Sale terminal according to claim 11, wherein
at the time of writing a predetermined setting, the write processing component cause a capacity of the predetermined storage region to which the setting is to be written to correspond to a capacity of a block which is a unit subjected to an erase process in the flash memory,
a capacity of a region associated with one-time writing of the setting is set to be a capacity obtained by the capacity of the predetermined storage region being divided by an integer, and
each region obtained by dividing the block by the integer is sequentially used in accordance with an update of the setting .

13. The Point-of-Sale terminal according to claim 12, wherein
prior to a next writing which is performed after the write processing component finishes using all regions obtained by dividing the block by the integer, the erase processing component erases data stored in the block.

14. The Point-of-Sale terminal according to claim 11, wherein
the write processing component updates the latest writing position of the management information

15. The Point-of-Sale terminal according to claim 11, wherein
when the erase processing component erases the entire storage region, a control component updates a latest writing position of management information, and the write processing component, referring to the management information, determines that all small regions of the storage region are blank.

16. The Point-of-Sale terminal according to claim 11, further comprising:
a payment processing component.

17. The Point-of-Sale terminal according to claim 11, further comprising:
a display.

18. The Point-of-Sale terminal according to claim 11, further comprising:
a thermal print head.
